(19) United States
(12) Patent Application Publication
(10) Pub. No.: US 2022/0092395 A1
(43) Pub. Date: Mar. 24, 2022

(54) COMPUTING DEVICE

(71) Applicant: HITACHI ASTEMO, LTD., Hitachinaka-shi, Ibaraki (JP)

(72) Inventor: Daichi MURATA, Tokyo (JP)

(73) Assignee: HITACHI ASTEMO, LTD., Hitachinaka-shi, Ibaraki (JP)

(21) Appl. No.: 17/420,823

(22) PCT Filed: Oct. 11, 2019
(86) PCT No.: PCT/JP2019/040272

§ 371 Date: Jul. 6, 2021

(30) Foreign Application Priority Data
Jan. 31, 2019 (JP) 2019-016217

(51) Int. Cl. G06N 3/063

(52) U.S. Cl. CPC G06N 3/063

(57) ABSTRACT

A computing device having input data and a neural network which performs an operation using a weighting factor includes a network analyzing unit which calculates a state of ignition of neurons of the neural network by the input data, and a contracting unit which narrows down candidates for contraction patterns from a plurality of contraction patterns to which a contraction rate of the neural network is set, based on the ignition state of the neurons, and executes the contraction of the neural network, based on the narrowed-down candidates for the contraction patterns to generate a post-contraction neural network.

### INCORPORATION BY REFERENCE

The present application claims the priority of Japanese Patent Application No. 2019-016217, which is a Japanese application filed on January 31, Hei 31 (2109), and incorporates it into this application by reference to its contents.

### Technical Field

The present invention relates to a computing device which utilizes a neural network.

### Background Art

As a technology of automatically performing recognition of objects and prediction of behavior, there has been known machine learning using a DNN (Deep Neural Network). When the DNN is applied to an automatic driving vehicle, it becomes necessary to reduce an amount of operation of the DNN in consideration of arithmetic capability of an in-vehicle device. As a technology of reducing the amount of operation of the DNN, there has been known, for example, Patent Literature 1.

There has been disclosed in Patent Literature 1, a technology of changing a threshold value of a weighting factor of a neural network to determine a threshold value directly before the generation of a large deterioration in recognition accuracy, and pruning a neuron smaller than the corresponding threshold value in the absolute value of the recognition accuracy to contract the DNN.

### CITATION LIST

### Patent Literature

PTL 1: U.S. Unexamined Patent Application Publication No. 2018/0096249, Specification

### SUMMARY OF INVENTION

### Technical Problem

The above related art is however accompanied by a problem that since the contraction (or optimization) of the DNN is executed by repeating relearning and inferring, combinations to be searched become enormous when the related art is applied to a large-scale neural network as in the DNN for the automatic driving vehicle, so that an enormous amount of time is required until the completion of processing.

Further, the above related art is accompanied by a problem that since the contraction of the neural network is implemented by a weighting factor, it is difficult to execute contraction according to an application to be destined for application.

Therefore, the present invention has been made in view of the above problems, and it is an object of the present invention to reduce an operation amount at the time of contraction and complete processing in a short time.

### Solution to Problem

The present invention provides a computing device having input data and a neural network which performs an operation using a weighting factor, which includes a network analyzing unit which calculates a state of ignition of neurons of the neural network by the input data, and a contracting unit which narrows down candidates for contraction patterns from a plurality of contraction patterns to which a contraction rate of the neural network is set, based on the ignition state of the neurons, and executes contraction of the neural network, based on the narrowed-down candidates for the contraction patterns to generate a post-contraction neural network.

### Advantageous Effects of Invention

Thus, since the contraction can be executed based on the state of ignition of each neuron, the preset invention is capable of reducing the amount of operation at the time of the contraction and thereby completing contraction processing in a short time. It is also possible to generate a neural network (DNN) corresponding to an application (or device) destined for application.

Details of at least one implementation of the subject matter disclosed in the present specification are set forth in the accompanying drawings and in the description below. Other features, aspects, and effects of the disclosed subject matter are manifested by the disclosures, drawings, and claims below.

### BRIEF DESCRIPTION OF DRAWINGS

FIG. 1 shows a first embodiment of the present invention and is a block diagram showing an example of a DNN contraction automating device.

FIG. 2 shows the first embodiment of the present invention and is a diagram showing an example of processing executed in the DNN contraction automating device.

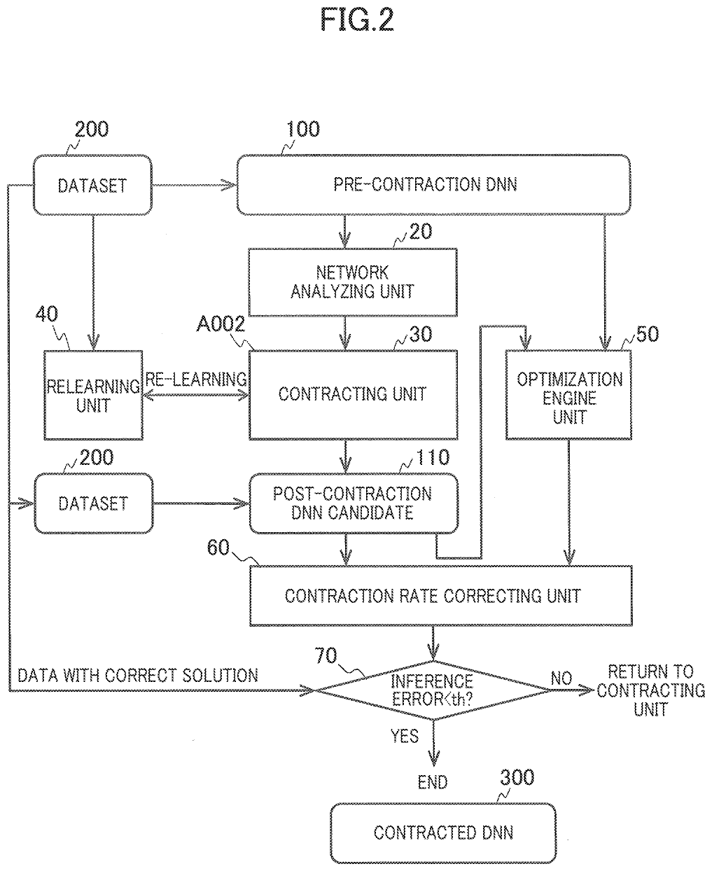

FIG. 3 shows the first embodiment of the present invention and is a diagram showing a relationship between a contraction pattern, a contraction rate, and sensitivity to recognition accuracy.

FIG. 4 shows the first embodiment of the present invention and is a graph showing a relationship between a design period and a contraction rate.

FIG. 5 shows a second embodiment of the present invention and is a block diagram of a vehicle control system, which shows an example in which a DNN contraction automating device is installed in a vehicle.

FIG. 6 shows a third embodiment of the present invention and is a diagram showing an example of processing executed in the DNN contraction automating device.

FIG. 7 shows a fourth embodiment of the present invention and is a diagram showing an example of processing executed in the DNN contraction automating device.

### DESCRIPTION OF EMBODIMENTS

Embodiments of the present invention will hereinafter be described with reference to the accompanying drawings.

### First Embodiment

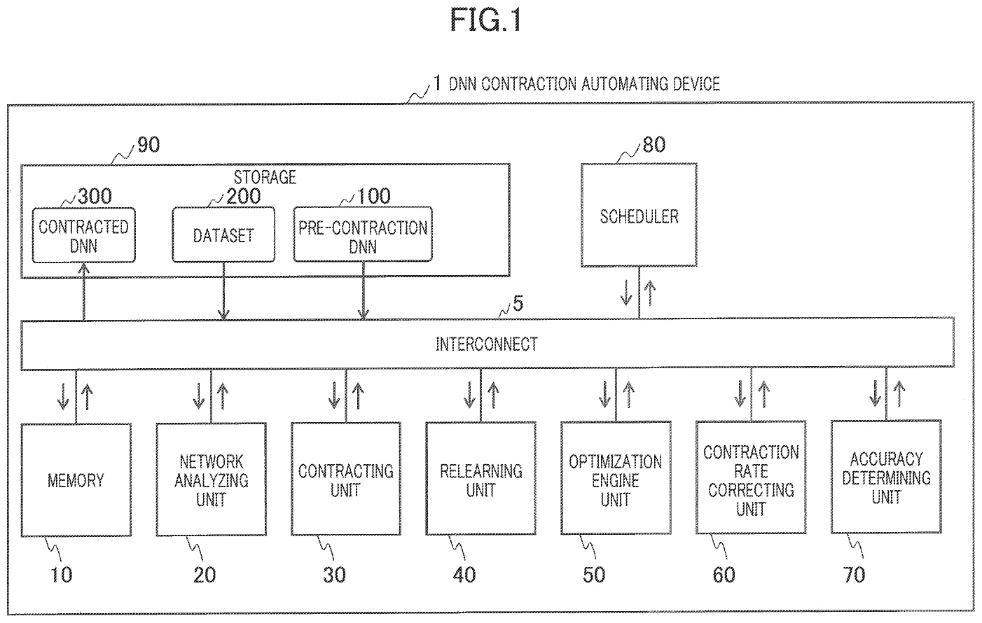

FIG. 1 shows a first embodiment of the present invention and is a block diagram illustrating an example of a DNN (Deep Neural Network) contraction automating device 1.

The DNN contraction automating device 1 is a computing device including a DNN 100 to be contracted (or optimized), a storage 90 which stores a dataset 200 input to the DNN 100, a memory 10 which holds intermediate data or the like therein, a network analyzing unit 20, a contracting unit 30, a relearning unit 40, an optimization engine unit 50, a contraction rate correcting unit 60, an accuracy determining unit 70, a scheduler 80 which controls respective functional parts of the network analyzing unit 20 to the accuracy determining unit 70, and an interconnect 6 which connects the respective units. Incidentally, as the interconnect 6, there can be adopted, for example, an AXi (Advanced eXtensible Interface).

Further, the memory 10 and the network analyzing unit 20 to the accuracy determining unit 70 function as slaves and the scheduler 80 functions as a master which controls the above slaves.

In the DNN contraction automating device 1 of the present first embodiment, the respective functional parts of the network analyzing unit 20 to the accuracy determining unit 70, and the scheduler 80 are implemented in hardware. The DNN contraction automating device 1 can be installed in, for example, an extension slot of a computer to perform transfer/reception of data. Incidentally, as the hardware, there can be adopted an ASIC (Application Specific Integrated Circuit) or the like.

Further, the present first embodiment shows an example in which each functional part is configured in hardware, but is not limited to this. For example, some or all of the network analyzing unit 20 to the scheduler 80 can also be implemented in software. Further, in the following description, each layer of the DNN will be described as a neural network.

The pre-contraction DNN 100 stored in the storage 90 includes a neural network, a weighting factor, and bias. Further, the dataset 200 is data corresponding to an application (or device) destined for application of the DNN 100, and includes data with correct solution and data for detecting a state of ignition (activation) of the neural network. A contracted DNN 300 is a result obtained by executing contraction processing in the network analyzing unit 20 to the accuracy determining unit 70.

When the scheduler 80 receives the pre-contraction DNN 100 and the dataset 200 therein, the scheduler 80 controls the respective functional parts described above in a preset order to execute the contraction processing of the neural network (neuron), thereby generating the contracted DNN 300.

The DNN contraction automating device 1 of the present first embodiment automatically calculates the optimal contraction rate from the dataset 200 corresponding to the application destined for application with the input pre-contraction DNN 100 and realizes shortening of a design period required for contraction of the contracted DNN 300.

In the present first embodiment, the contraction rate is expressed in the operation amount of the contracted DNN 300/operation amount of the pre-contraction DNN 100. However, the operation amount can make use of the number of processing amounts per unit time (Operation per second). Incidentally, the contraction rate can be expressed in the neuron number of the contracted DNN 300/neuron number of the pre-contraction DNN 100 in addition to the above. Alternatively, the contraction rate can be expressed in the node number of the contracted DNN 300/node number of the pre-contraction DNN 100.

Hereinafter, description will be made about details of each functional part after the outline of processing executed in the DNN contraction automating device 1 is described.

<Outline of Processing>

First, the scheduler 80 inputs the pre-contraction DNN 100 to the network analyzing unit 20. The scheduler 80 inputs data corresponding to the application destined for application from the dataset 200 to the network analyzing unit 20 to allow the network analyzing unit 20 to calculate a feature amount of the DNN 100.

The network analyzing unit 20 inputs the data of the dataset 200 to the DNN 100 to calculate a feature amount from the state of ignition of neurons of the neural network. Then, the scheduler 80 inputs the feature amount calculated in the network analyzing unit 20 to the contracting unit 30 to allow the contracting unit 30 to execute narrowing down of combination candidates for promising contraction rates.

The contracting unit 30 calculates a sensitivity to the recognition accuracy of the neural network from the feature amount, sets high the contraction rate with respect to a portion thereof low in sensitivity, and sets low the contraction rate with respect to a portion thereof high in sensitivity.

The contracting unit 30 sets the above contraction rate with respect to the neural network of each layer of the DNN 100, generates a plurality of combination candidates for the contraction rates, and narrows down the candidates that satisfies the conditions of the contraction rate and the recognition accuracy (sensitivity to the recognition accuracy) from among these candidates. Incidentally, in the following description, the combination candidates for the contraction rates will be defined as contraction patterns. Then, the contracting unit 30 performs the contraction of the DNN 100 on each narrowed-down contraction pattern and outputs the same as a post-contraction candidate of DNN (DNN candidate 110).

While the contracting unit 30 is performing contraction, the scheduler 80 allows the relearning unit 40 to repeatedly execute relearning of the DNN. The relearning unit 40 constructs the DNN candidate 110 robust to the contraction by relearning. Next, the scheduler 80 inputs the post-contraction DNN candidate 110 output from the contacting unit 30 and the DNN 100 to the optimization engine unit 50 to allow the optimization engine unit 50 to perform optimization.

The optimization engine unit 50 performs the optimization of the contraction rate, the selection of a contraction method, etc. on the post-contraction DNN candidate 110 to determine a correction value of a parameter (weighting factor or the like, for example) required for contraction. The optimization engine unit 50 estimates, for example, the optimal contraction pattern and parameter from an inference error in the post-contraction DNN candidate 110 by using the optimization algorithm based on Bayesian inference and determines the correction value of the contraction rate for each neural network.

The optimization engine unit 50 outputs the calculated contraction pattern and parameter to the contraction rate correcting unit 60. The contraction rate correcting unit 60 applies the above contraction rate and parameter to the post-contraction DNN candidate 110 to correct the contraction rate and construct the post-contraction DNN candidate 110. The scheduler 80 inputs the post-contraction DNN candidate 110 constructed in the contraction rate correcting unit 60 to the accuracy determining unit 70 to allow the accuracy determining unit 70 to execute inference.

The accuracy determining unit 70 acquires data with correct solution from the dataset 200 and inputs the same to the post-contraction DNN candidate 110 to execute inference. The accuracy determining unit 70 determines an inference error (or inference accuracy) in the post-contraction DNN candidate 110 from the result of inference and the correct solution and repeats the above processing until the inference error becomes less than a predetermined value th. Incidentally, the inference error may make use of, for example, a statistical value (average value or the like) based on the reciprocal of the correction solution rate of the inference result of the DNN candidate 110.

Then, the accuracy determining unit 70 outputs the DNN candidate 110 whose inference error is less than the predetermined value th, of the contraction patterns narrowed down by the contracting unit 30, as the contracted DNN 300 whose optimization is completed.

As described above, the DNN contraction automating device 1 performs (1) the analysis of the DNN 100 by the network analyzing unit 20, (2) execution of narrowing down and contraction of candidates of combinations (contraction patterns) of the plural contraction rates by the contracting unit 30, (3) relearning of the DNN to be contracted by the relearning unit 40, (4) optimization of the parameter by the optimization engine unit 50 and reconstruction of the post-contraction DNN candidate 110 in the contraction rate correcting unit 60, and (5) determination as to the inference error in the post-contraction DNN candidate 110 by the accuracy determining unit 70, and is capable of automatically outputting the DNN 300 whose inference error is less than the threshold value th from among the plural contraction patterns.

The DNN contraction automating device 1 analyzes the pre-contraction DNN 100 and repeats the above processing of (1) to (5) until the inference error becomes less than the predetermined threshold value th, thereby making it possible to automatically generate the contracted DNN 300 excellent in contraction rate and inference accuracy (recognition accuracy) from among the plural contraction patterns according to the application (or device) destined for application of the DNN 300.

The DNN contraction automating device 1 analyzes the neural network of the pre-contraction DNN 100 on the basis of the dataset corresponding to the application destined for application of the DNN 300 to calculate a feature amount (ignition state), whereby it is possible to narrow down the promising combination of contraction rates and then perform its search, and it is possible to reduce the amount of operation at the time of contraction and thereby complete the processing in a short time.

Further, the DNN contraction automating device 1 combines probabilistic searches by Bayesian inference in addition to the narrowing down of the candidates for the contraction patterns, thereby making it possible to output the contracted DNN 300 which minimizes a decrease in recognition accuracy within the range that satisfies the threshold value th.

<Details of Functional Part>

First, the network analyzing unit 20 analyzes the sensitivity to the recognition accuracy by the contraction and calculates a feature amount of the pre-contraction DNN 100 for each neural network. The network analyzing unit 20 reads a plurality of data corresponding to the application destined for application of the contracted DNN 300 from the dataset 200 and sequentially inputs the same to the pre-contraction DNN 100 to estimate (digitalize) an ignition state for each neural network of the DNN 100 and take it as a feature amount.

Also, the network analyzing unit 20 may calculate an ignition state of neurons of the neural network as a heat map and take the heat map as a feature amount. Further, the feature amount calculated by the network analyzing unit 20 is not limited for each neural network, but, for example, may be calculated for each neuron.

As a technology of estimating and digitalizing the ignition state of each neuron, a known or well-known technology can be applied, for example, a technology disclosed in International Publication No. 2011/007569 may be applied.

In the present first embodiment, attention is paid to the point in which a neuron ignited according to the feature of data destined for application and a non-ignited neuron differ in distribution. The state of ignition of each neuron by the dataset 200 corresponding to the application destined for application of the DNN 300 is taken as the feature amount. Incidentally, the feature amount may be taken as a statistic value where the plural data are sequentially input to the DNN 100. Further, the feature amount is output as an analysis result containing a feature specific to the application destination for the contracted DNN 300.

The network analyzing unit 20 is capable of determining the neuron (or neural network) frequently ignited on the input data to be large in sensitivity to the recognition accuracy and reversely determining the neuron (or neural network) low in igniting frequency to be low in sensitivity to the recognition accuracy.

The contracting unit 30 receives the feature amount based on the state of ignition of the neural network (or neuron) from the network analyzing unit 20, narrows down the candidates for the combination of the contraction rates (contraction patterns) and executes contraction. The contracting unit 30 performs narrowing down from the candidates for the plural contraction patterns, based on the feature amount for each neural network and performs contraction on the plural narrowed-down contraction patterns to generate a post-contraction DNN candidate 110.

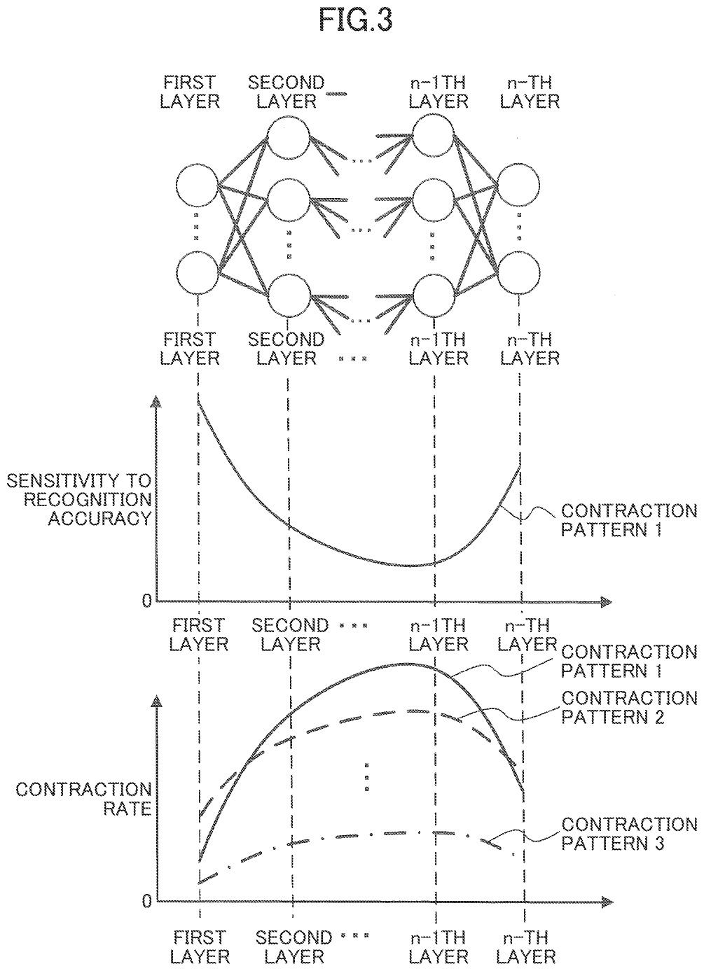

FIG. 3 is a diagram illustrating a relationship between the contraction pattern, the contraction rate, and the sensitivity to the recognition accuracy. In the example of FIG. 3, there is shown an example in which a DNN 100 is configured with an n-layer neural network, and the contraction rate is set for each layer. In the illustrated example, a first layer serves as an input layer, second to n-1th layers serve as hidden layers (intermediate layers), and an nth layer serves as an output layer.

In the present first embodiment, each individual contraction pattern has a contraction rate of each layer. In other words, the contraction pattern is constituted of the combination of the contraction rates for each layer.

The contraction patterns 1 to 3 are respectively set by the combinations different in contraction rate for each layer (neural network). The contraction pattern may make use of a pattern set in advance, or may be generated by the contacting unit 30 from the preset combinations of contraction rates. Further, the number of contraction patterns is not limited to three, but can be changed as appropriate according to the scale of the DNN 100.

As described above, in terms of the neural network high in sensitivity to the recognition accuracy of the data corresponding to the application destination of the DNN 300, the contracting unit 30 sets the contraction rate low. Thus, a region high in the above sensitivity suppresses the number of neurons from decreasing more than necessary and the recognition (estimation) accuracy from being degraded.

On the other hand, the contraction rate is set high in terms of the neural network low in sensitivity to the recognition accuracy of the data corresponding to the application destination of the DNN 300. Thus, in a region low in the sensitivity, even if the number of neurons is substantially reduced, it is possible to suppress the recognition accuracy from being degraded and also reduce the operation amount.

In terms of the relationship between the sensibility and the contraction rate, for example, the contraction rate of the neural network whose sensitivity to the recognition accuracy is 70% is taken to be 30%, and the contraction rate of the neural network whose sensitivity to the recognition accuracy is 30% is taken to be 70%.

Since the reduceable neurons increase in a chain reaction as the contraction rate is increased, it is possible to substantially reduce the operation amount. On the other hand, a problem arises in that when the contraction rate is increased regardless of the sensitivity to the recognition accuracy, the recognition accuracy is degraded (expansion in estimation error). However, as in the present first embodiment, it is possible to search for the optimal solution for the contraction rate and the recognition accuracy by associating the feature amount of the neural network with the sensitivity to the recognition accuracy.

Incidentally, there is shown above the example in which the contraction rate is set for each neural network, but the present invention is not limited to this. For example, the neurons to be contracted and the neurons to be maintained may be sorted according to the feature amount of each neuron in the neural network while maintaining the contraction rate for each layer.

Thus, the contracting unit 30 determines the contraction rate for each neural network, based on the feature amount to substantially reduce the number of neurons and then enable operations such as the optimization of the contraction pattern, etc., thereby making it possible to shorten an operation time.

Next, the contracting unit 30 executes narrowing down from the plural contraction patterns to take an operation time for contraction processing to be an actual value. As an example of narrowing down, the contraction patterns are narrowed down to the contraction patterns from the top to the predetermined order in descending order of the contraction rates of the whole DNN and the sensitivity to the recognition accuracy. Alternatively, the known or well-known technology may be applied to narrowing down such as narrowing down to contraction patterns whose contraction rates are more than the predetermined value.

The contracting unit 30 performs contraction on the plural narrowed-down contraction patterns and output the same as the post-contraction DNN candidates 110.

As described above, the relearning unit 40 performs relearning by the dataset 200 on the DNN being in contraction by the contracting unit 30. Consequently, it is possible to construct the DNN high in generalization performance (=robust to the contraction).

The relearning unit 40 receives the DNN being in contraction and the candidate for the optimal solution of the parameter (weighting factor) of the DNN as inputs and performs learning again with the received DNN and parameter as initial values to reconstruct the DNN. A reconstructed result is output as the relearned neural network and the relearned weighting factor.

The optimization engine unit 50 performs inference by the dataset 200 on the plural DNN candidates 110 output from the contracting unit 30 to calculate an inference error and estimates the optimal combination of contraction rates (contraction patterns), based on the inference error. That is, the optimization engine unit 50 performs a probabilistic search based on Bayesian inference to probabilistically determine each contraction rate appropriate for each neuron. Then, the optimization engine unit 50 outputs the combination of the determined contraction rates (contraction patterns) to the contraction rate correcting unit 60.

The optimization engine unit 50 calculates the contraction pattern minimal in inference error out of the contraction patterns corresponding to the plural DNN candidates 110, which are output from the contracting unit 30.

Further, the optimization engine unit 50 may receive the plural DNN candidates 110 and the relearned weighting factor as inputs from the contracting unit 30 and estimate the contraction pattern by using the probabilistic search based on Bayesian inference.

The contraction rate correcting unit 60 corrects the contraction rate of the post-contraction DNN candidate 110 by the contraction rate received from the optimization engine unit 50 to reconstruct the DNN candidate.

The accuracy determining unit 70 inputs data with correct solution to the DNN candidate 110 to execute inference. If the inference error in the post-contraction DNN candidate 110 is less than the predetermined threshold value th from the result of inference and the correct solution, the accuracy determining unit 70 outputs the data as the contacted DNN 300 in which contraction is completed.

On the other hand, when the inference error is greater than the predetermined threshold value th, the accuracy determining unit 70 notifies the repetition of processing to the scheduler 80. When the notification of the repetition of processing is received from the accuracy determining unit 70, the scheduler 80 causes the contracting unit 30 to execute the repetition of processing.

As described above, the DNN contraction automating device 1 allows the network analyzing unit 20 to calculate the feature amount, based on the state of ignition of neurons, allows the contracting unit 30 to perform narrowing down to the promising contraction patterns and then execute contraction to output the plural DNN candidates 110, allows the relearning unit 40 to execute relearning of the DNN candidates 110 to be contracted, allows the optimization engine unit 50 to calculate the appropriate contraction rate, based on the error in inference, allows the contraction rate correcting unit 60 to reconstruct the DNN candidates 110 at the appropriate contraction rate, and allows the accuracy determining unit 70 to make a decision as to the inference error of each post-contraction DNN candidate 110, thereby making it possible to automatically output the DNN 300 whose inference error is less than the threshold value th, from among the plural contraction patterns (DNN candidates 110).

The DNN contraction automating device 1 calculates the feature amount based on the ignition state in accordance with the dataset 200 corresponding to the application (or device) destined for application of the DNN 300 to enable narrowing down to the contraction pattern excellent in contraction rate and recognition accuracy, thereby making it possible to reduce the operation amount at the time of contraction and thereby complete the contraction processing in a short time. Further, since the contraction processing of the DNN 100 does not require manpower, the DNN contraction automating device 1 is capable of significantly reducing labor required for the contraction of the DNN 100.

Further, since the state of ignition of neurons is estimated by the dataset 200 corresponding to the application destined for application, the DNN contraction automating device 1 of the present first embodiment is capable of generating the DNN corresponding to the environment destined for application of the contracted DNN 300.

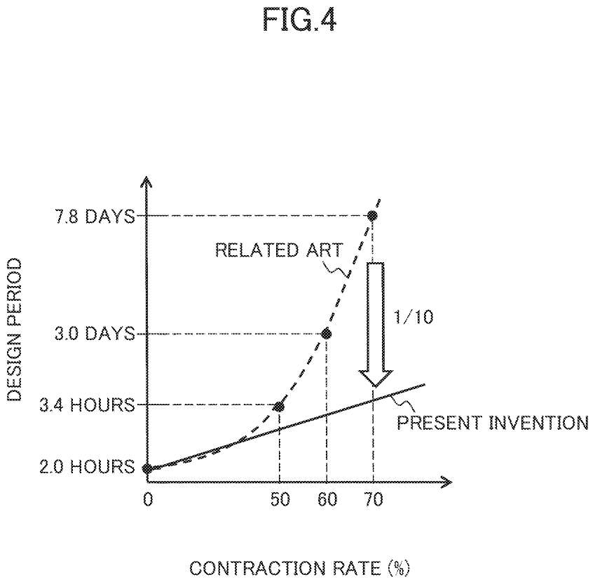

FIG. 4 is a graph showing a relationship between a design period and a contraction rate required for contraction of the DNN 100. In the illustrated graph, the horizontal axis is taken to be the contraction rate, and the vertical axis is taken to be the design period for contraction.

A solid line in the drawing indicates a relationship between the contraction rate and the design period (processing time) where a large-scale DNN 100 is contracted by the DNN contraction automating device 1 of the present first embodiment. A broken line in the drawing indicates an example in which the large-scale DNN 100 is contracted by manpower.

In the DNN contraction automating device 1 of the present first embodiment, the contraction of the contraction rate=70% that required 7 to 8 days by manpower can be completed in about 1/10 being ≅10 hours. Further, in the DNN contraction automating device 1 of the present first embodiment, the narrowing down of the promising combination of contraction rates (contraction patterns) by the network analyzing unit 20 makes it possible to significantly shorten the design period for contraction and improve the recognition accuracy.

### Second Embodiment

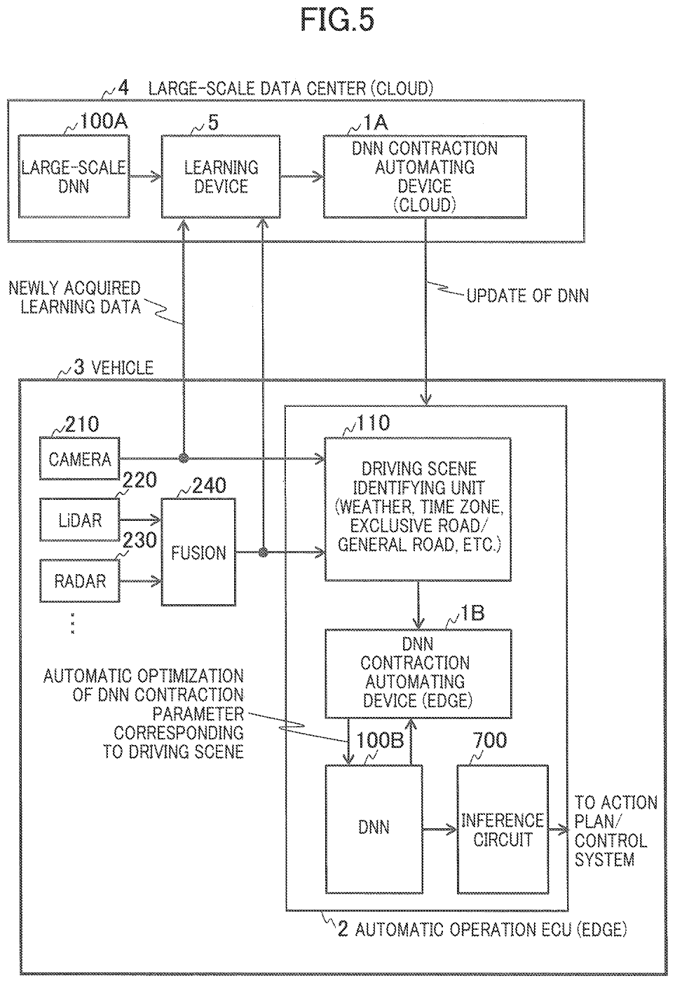

FIG. 5 shows a second embodiment of the present invention and is a block diagram of a vehicle control system, which shows an example in which a DNN contraction automating device is installed in a vehicle. In the present second embodiment, there is shown an example in which the DNN contraction automating device 1 shown in the first embodiment described above is arranged in each of a vehicle (edge) 3 capable of automatic operation and a data center (cloud) 4, and the contraction of a DNN 100B is optimized according to a traveling environment of the vehicle 3 which performs the automatic operation.

The data center 4 includes a DNN contraction automating device 1A and a learning device 5 which performs learning on a large-scale DNN 100A and executes a substantial update of the DNN 1000A. The data center 4 is connected to the vehicle 3 through a wireless network (not shown).

The learning device 5 acquires information about a traveling environment and a traveling state from the vehicle 3. The learning device 5 executes learning of the DNN 1000A based on the information acquired from the vehicle 3. The learning device 5 inputs the learning-completed DNN 100A to the DNN contraction automating device 1A as a pre-contraction DNN.

The DNN contraction automating device 1A is configured in a manner similar to the first embodiment described above and outputs the contracted DNN therefrom. The data center 4 transmits the DNN output from the DNN contraction automating device 1A to the vehicle 3 in a predetermined timing to request an update.

The vehicle 3 has a camera 210, LiDAR (Light Detection And Ranging) 220, sensors of a radar 230, a fusion 240 which combines data from the sensors, and an automatic operation ECU (Electronic Control Unit) 2 which executes automatic operation, based on information from the camera 210 and the fusion 240. Incidentally, the information acquired by the camera 210 and the fusion 240 is transmitted to the data center 4 through the wireless network.

The automatic operation ECU 2 includes a driving scene identifying unit 120, a DNN contraction automating device (edge) 1A, a DNN 100B, and an inference circuit 700.

The driving scene identifying unit 120 detects the traveling environment of the vehicle 3, based on an image from the camera 210 and sensor data from the fusion 240 and instructs the DNN contraction automating device 1B to correct the DNN 100B when the traveling environment is changed. The traveling environment detected by the driving scene identifying unit 120 includes, for example, the classification of roads such as general roads, highways, etc., a time zone, weather, etc.

The contents of correction of the DNN 100B that the driving scene identifying unit 120 instructs the DNN contraction automating device 1B include, for example, the conditions for contraction and a method for contraction. These contents of correction are set in advance according to the traveling environment.

The DNN contraction automating device 1B contracts the DNN 100B with the instructed contents of correction and outputs the post-contraction DNN to the inference circuit 700. The inference circuit 700 performs predetermined recognition processing from the sensor data and the image data of the camera 210 by using the post-contraction DNN and outputs the same to a control system (not shown). Incidentally, the control system includes a driving force control device, a steering device, a control device, and a navigation device.

The data center 4 performs learning processing of the large-scale DNN 100A, based on the sensor data acquired from the vehicle 3. The DNN contraction automating device 1A performs contraction processing on the learned DNN 100A to execute its update. The contents of the update include, for example, addition of an object to be recognized, a reduction in misrecognition, etc. and improves the recognition accuracy of the DNN 100A.

In the vehicle 3, when the driving scene identifying unit 120 detects a change in the traveling environment, the DNN contraction automating device 1B executes the correction of the DNN 100B to make it possible to ensure the recognition accuracy adapted to the traveling environment.

Further, the vehicle 3 receives the updated DNN from the data center 4 to update the DNN 100B, thereby making it possible to realize automatic operation by the latest DNN.

### Third Embodiment

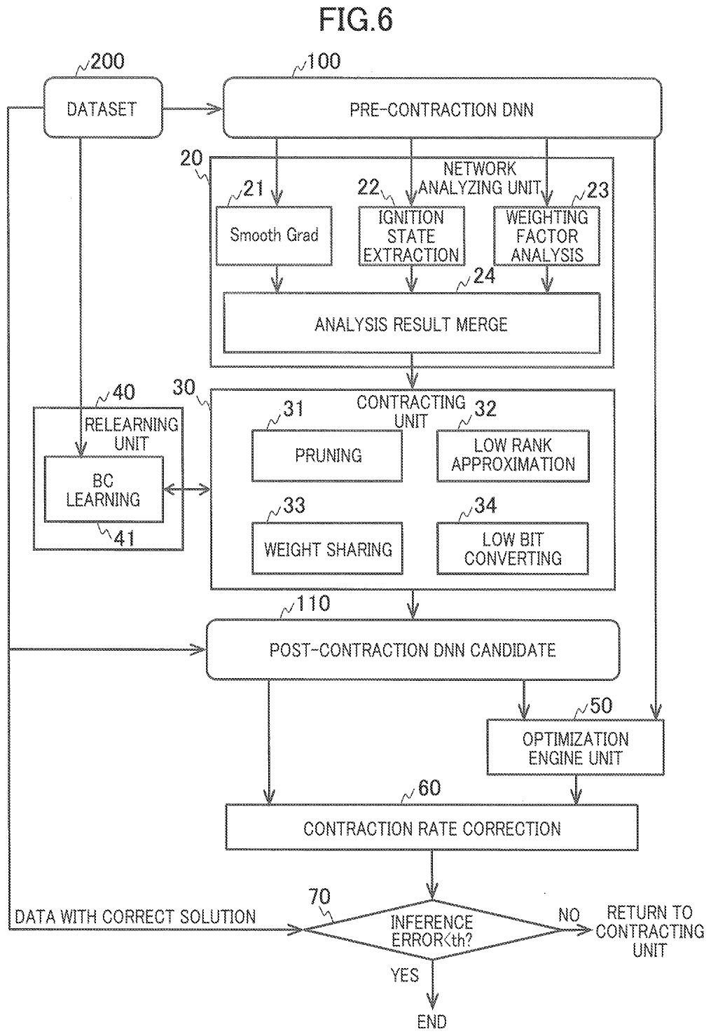

FIG. 6 shows a third embodiment of the present invention and is a diagram showing an example of processing executed in the DNN contraction automating device. The present third embodiment shows an example of including in a plurality of methods of calculating the feature amount of the DNN contraction automating device 1 shown in the above-described first embodiment, and a contraction method thereof. Incidentally, other configurations are similar to those of the DNN contraction automating device 1 of the first embodiment described above.

The network analyzing unit 20 includes a SmoothGrad 21, an ignition state extraction 22, a weighting factor analysis 23, and an analysis result merge 24.

When the DNN 100 recognizes an object, the SmoothGrad 21 outputs a region of an input image to which a neural network pays attention. The ignition state extraction 22 outputs whether neurons in the neural network are zero or non-zero upon the recognition of data. The weighting factor analysis 23 is capable of analyzing the strength (weight) of binding of neurons in the DNN 100 and taking a portion weak in binding to be an object to be contracted.

The analysis result merge 24 integrates results of the SmoothGrad 21, the ignition state extraction 22, and the weighting factor analysis 23 to calculate a feature amount of the neural network.

The contracting unit 30 includes pruning 31, Low rank (low in rank) approximation 32, Weight Sharing (share in weight) 33, and low bit converting 34.

The pruning 31 and the Low rank approximation 32 reduce unnecessary or less-affected neurons and executes contraction. The Weight Sharing 33 reduces the amount of data by sharing a weighting factor in the bindings of plural neurons. The low bit converting 34 limits a bit width used in operation to reduce a computational load. However, the limitation of the bit width is taken to be within a range in which an inference error is allowed.

The contracting unit 30 executes contraction in accordance with any of the four contraction methods described above or the combination of a plurality of contraction methods. The scheduler 80 may instruct which contraction method to apply.

Further, it is possible to generate a DNN capable of ensuring recognition accuracy even after the contraction by applying BC (Between-class) learning 41 as an example of the relearning unit 40.

The network analyzing unit 20, the contracting unit 30, and the relearning unit 40 are capable of generating a DNN excellent in contraction rate and recognition accuracy by utilizing such components as described above. For example, as in the above second embodiment, when the correction of the DNN is performed according to the traveling environment as in the edge device (automatic operation ECU2), the contraction method of the contracting unit 30 may be set to be selected from the above-described pruning 31 to low bit converting 34.

Further, the contracting unit 30 exemplifies the pruning 31, the Low rank (low in rank) approximation 32, the Weight Sharing (share in weight) 33, and the low bit converting 34 as a plurality of contraction execution parts different in contraction method, but is not limited to these. A contraction method corresponding to the application destination of the DNN 300 having been contracted may adopted as appropriate.

### Fourth Embodiment

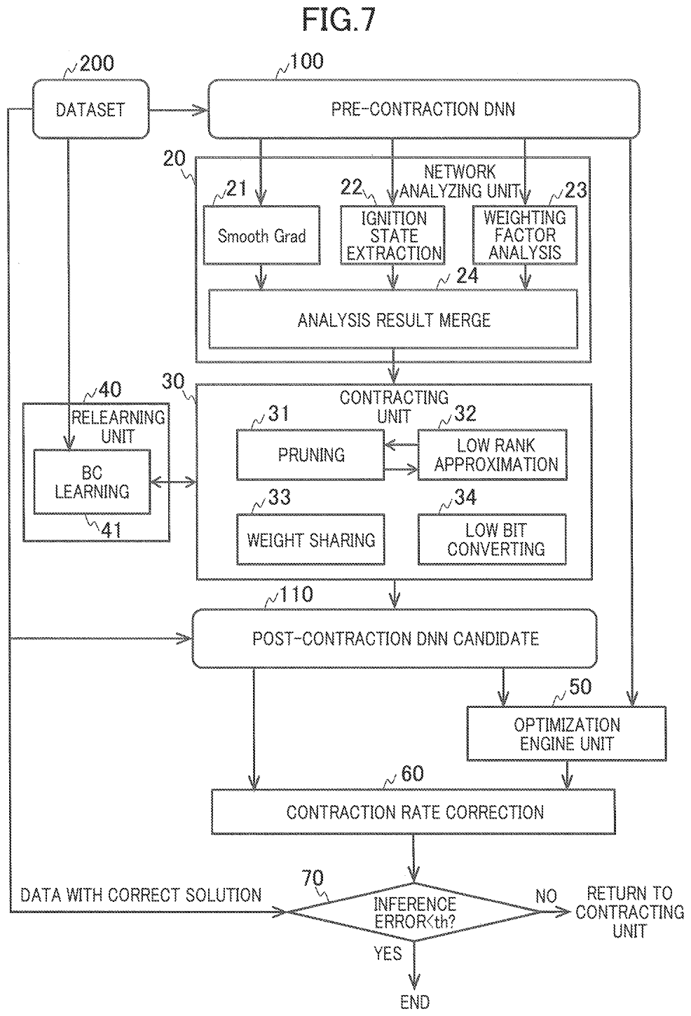

FIG. 7 shows a fourth embodiment of the present invention and is a diagram showing an example of processing executed in the DNN contraction automating device 1. In the present fourth embodiment, contraction information is shared between the pruning 31 and the Low rank approximation 32 in the contracting unit 30 of the DNN contraction automating device 1 shown in the above-described third embodiment.

Neurons contracted in the pruning 31 and a matrix contracted in the Low rank approximation 32 are linked with each other to reduce unnecessary operations, thereby making it possible to speed up processing. The amount of operation in the contracting unit 30 is reduced to make it possible to shorten the time required for contraction of the DNN contraction automating device 1.

<Summary>

As described above, the DNN contraction automating devices 1 of the above first to fourth embodiments can be configured as follows:

(1). A computing device (DNN contraction automating device 1) having input data (dataset 200) and a neural network (DNN 100) which performs an operation using a weighting factor is provided including a network analyzing unit (20) which calculates a state of ignition of neurons of the neural network (DNN 100) by the input data (200), and a contracting unit 30 which narrows down candidates for contraction patterns from a plurality of contraction patterns to which a contraction rate of the neural network (100) is set, based on the ignition state of the neurons, and executes the contraction of the neural network (100), based on the narrowed-down candidates for the contraction patterns to generate a post-contraction neural network (110).

The network analyzing unit 20 focuses on the point in which neurons ignited depending on the features of a destination to be applied and non-ignited neurons are different in distribution, and takes the state of ignition of the neurons by the dataset 200 corresponding to an application destined for the application of the DNN 300 to be a feature amount. Then, the network analyzing unit 20 associates the feature amount of the neural network (DNN 100) with sensitivity to the recognition accuracy to thereby make it possible to search for the optimal solution for the contraction rate and the recognition accuracy.

The contracting unit 30 determines the contraction rate for each neural network, based on the feature amount to significantly reduce the number of neurons and then enable operations such as optimization of each contraction pattern, thus making it possible to shorten an operation time required for the contraction.

(2). The computing device described in the above (1) further includes an optimization engine unit (50) which performs inference on the post-contraction neural network (110) generated in the contracting unit (30) to calculate an inference error and extracts the contraction pattern based on the inference error from among the plural contraction patterns.

With the above configuration, the DNN contraction automating device 1 feeds back the inference error of the post-contraction DNN candidate 110 to the contraction rate (contraction pattern) in the optimization engine unit 50, thereby making it possible to generate a contracted DNN 300 high in recognition accuracy.

(3). In the computing device described in the above (2), the optimization engine unit (50) extracts a contraction pattern minimized in the inference error.

With the above configuration, the DNN contraction automating device 1 is capable of generating the contracted DNN 300 high in recognition accuracy by the contraction pattern minimized in inference error.

(4). The computing device described in the above (1) further includes a relearning unit (40) which performs learning again on the post-contraction neural network (110) generated in the contracting unit (30) in accordance with the input data (200).

With the above configuration, it is possible to construct a DNN high in generalization performance (robust to contraction).

(5). The computing device described in the above (2) further includes a relearning unit (40) which performs learning again on the post-contraction neural network (110) generated in the contracting unit (30) in accordance with the input data (200). The computing device further has a memory (10) which temporarily stores intermediate data in the middle of operation of the network analyzing unit (20), the contracting unit (30) and the optimization engine unit (50), and the relearning unit (40), a scheduler (80) which takes the network analyzing unit (20), the contracting unit (30), the relearning unit (40), the optimization engine unit (50), and the memory (10) to be slaves, and serves as a master which controls the slaves, and an interconnect (5) which connects the master and the slaves.

With the above configuration, it is possible to speed up contraction processing by configuring the DNN contraction automating device 1 with hardware.

(6). In the computing device described in the above (1), the network analyzing unit (20) receives input data (200) corresponding to the neural network (100) and a destination for application of the post-contraction neural network (300), calculates a feature amount obtained by estimating and digitalizing the state of ignition of each neuron of the neural network (100), and outputs the feature amount as an analysis result including a feature specific to the application destination.

Using the feature amount based on the state of ignition of neurons by the dataset 200 corresponding to the application destination of the contracted DNN 300 as the analysis result makes it possible to provide the combination of contraction rates optimal to an application destined for application.

(7). In the computing device described in the above (6), the contracting unit (30) receives the analysis result of the network analyzing unit (20), executes contraction of a neural network (100), based on the feature amount digitalized in the analysis result, and outputs a plurality of optimal solution candidates for the post-contraction neural network (110) and the weighting factor.

With the above configuration, the DNN contraction automating device 1 is capable of narrowing down to the contraction pattern excellent in contraction rate and recognition accuracy by the calculation of the feature amount and completing contraction processing in a short time by reducing the amount of operation at the time of contraction. Further, since no manpower is required for the contraction processing of the DNN 100, the DNN contraction automating device 1 is capable of significantly reducing labor required for the contraction of the DNN 100.

(8). In the computing device described in the above (1), the contracting unit (30) includes a plurality of contraction execution parts (pruning 31, Low rank approximation 32, weight sharing 33, and low bit converting 34) different in contraction method and switches the contraction execution parts (31) to 34 according to the application destination of the neural network (300).

With the above configuration, the contracting unit 30 is capable of selecting the contraction method corresponding to the application destination of the contracted DNN 300 and thereby achieving a reduction in processing time and an improvement in recognition accuracy.

(9). The computing device described in the above (7) further includes a relearning unit (40) which performs learning again on the post-contraction neural network (110) output by the contracting unit (30) in accordance with the input data (200). The relearning unit (40) receives the optimal solution candidates for the neural network (200) and the weighting factor as inputs and performs learning again with the neural network (200) and the weighting factor as initial values to thereby output the relearned neural network (110) and the relearned weighting factor.

With the above configuration, the relearning unit 40 is capable of generating the DNN 300 capable of ensuring the recognition accuracy even after the contraction.

(10). The computing device described in the above (9) further includes an optimization engine unit (50) which performs inference on the post-contraction neutral network (110) on which the contraction is executed in the contracting unit (30) to calculate an inference error, and extracts a contraction pattern from among the plural contraction patterns, based on the inference error. The optimization engine unit (50) receives a plurality of the neural networks (110) and the relearned weighting factor as inputs and calculates the contraction pattern by using a probabilistic search set in advance.

With the above configuration, the optimization engine unit 50 is capable of estimating a contraction pattern that can reduce the inference error.

Incidentally, the present invention is not limited to the above-described embodiments and includes various modifications. For example, the above-described embodiments have been described in detail to explain the present invention in an easy-to-understand manner, and are not necessarily limited to those having all the configurations described. Also, a part of the configuration of one embodiment can be replaced with the configuration of another embodiment. Further, the configuration of another embodiment can be added to the configuration of one embodiment. In addition, any of addition/deletion/replacement of other configurations with respect to parts of the configurations of the respective embodiments can be applied even alone or in combination.

Further, in regard to the above-described respective configurations, functions, processing parts and processing means, etc., some or all thereof may be realized in hardware, for example, by being designed with integrated circuits, and the like. In addition, the above-described respective configurations and functions, etc. may be realized in software by allowing a processor to interpret and execute a program realizing each function. Information about a program, a table, a file, etc. that realize each function can be put in a recording device such as a hard disk, an SSD (Solid State Drive) or the like, or a recording medium such as an IC card, an SD card, a DVD or the like.

Further, control lines and information lines indicate what is considered necessary for explanation, but do not necessarily indicate all controls lines and information lines on the product. In practice, it may be considered that almost all configurations are interconnected.

1. A computing device having input data and a neural network which performs an operation using a weighting factor, comprising:
a network analyzing unit which calculates a state of ignition of neurons of the neural network by the input data; and
a contracting unit which narrows down candidates for contraction patterns from a plurality of contraction patterns to which a contraction rate of the neural network is set, based on the ignition state of the neurons, and executes contraction of the neural network, based on the narrowed-down candidates for the contraction patterns to generate a post-contraction neural network.

2. The computing device according to claim 1, further including an optimization engine unit which performs inference on the post-contraction neural network generated in the contracting unit to calculate an inference error and extracts the contraction pattern based on the inference error from among the plural contraction patterns.

3. The computing device according to claim 2, wherein the optimization engine unit extracts the contraction pattern minimized in the inference error.

4. The computing device according to claim 1, further including a relearning unit which performs learning again on the post-contraction neural network generated in the contracting unit in accordance with the input data.

5. The computing device according to claim 2, further including a relearning unit which performs learning again on the post-contraction neural network generated in the contracting unit in accordance with the input data, and
further including:
a memory which temporarily stores intermediate data in the middle of operation of the network analyzing unit, the contracting unit and the optimization engine unit, and the relearning unit,
a scheduler which takes the network analyzing unit, the contracting unit, the relearning unit, the optimization engine unit, and the memory to be slaves, and serves as a master which controls the slaves, and
an interconnect which connects the master and the slaves.

6. The computing device according to claim 1, wherein the network analyzing unit receives input data corresponding to the neural network and a destination for application of the post-contraction neural network, calculates a feature amount obtained by estimating and digitalizing the state of ignition of each neuron of the neural network, and outputs the feature amount as an analysis result including a feature specific to the application destination.

7. The computing device according to claim 6, wherein the contracting unit receives the analysis result of the network analyzing unit, executes contraction of a neural network, based on the feature amount digitalized in the analysis result, and outputs a plurality of optimal solution candidates for the post-contraction neural network and the weighting factor.

8. The computing device according to claim 1, wherein the contracting unit includes a plurality of contraction execution parts different in contraction method and switches the contraction execution parts according to the application destination of the neural network.

9. The computing device according to claim 7, further including a relearning unit which performs learning again on the post-contraction neural network output by the contracting unit in accordance with the input data,
wherein the relearning unit receives the optimal solution candidates for the neural network and the weighting factor as inputs and performs learning again with the neural network and the weighting factor as initial values to thereby output the relearned neural network and the relearned weighting factor.

10. The computing device according to claim 9, further including an optimization engine unit which performs inference on the post-contraction neutral network on which the contraction is performed in the contracting unit to calculate an inference error, and extracts a contraction pattern from among the plural contraction patterns, based on the inference error,
wherein the optimization engine unit receives a plurality of the neural networks and the relearned weighting factors as inputs and calculates the contraction pattern by using a probabilistic search set in advance.
